(19) United States
(12) Patent Application Publication
(10) Pub. No.: US 2008/0282320 A1
(43) Pub. Date: Nov. 13, 2008

(54) Security Compliance Methodology and Tool

(76) Inventors: Andrew DeNovo, Arlington Heights, IL (US); Charles R. Loeb, Prospect Heights, IL (US)

Correspondence Address: Husch Blackwell Sanders, LLP;Welsh & Katz, 120 S RIVERSIDE PLAZA, 22ND FLOOR, CHICAGO, IL, 60606, US

(21) Appl. No.: 12/118,109

(22) Filed: May 9, 2008

Related U.S. Application Data
(60) Provisional application No. 60/928,833, filed on May 11, 2007.

(51) Int. Cl. G06F 21/00

(52) U.S. Cl. 726/1

(57) ABSTRACT

An apparatus is provided for evaluating risk to an organization. The apparatus includes a plurality of governmental rules directed to protecting shareholders, a plurality of security domains of the organization wherein each security domain is associated with a different asset of the organization and a request for an information risk assessment within at least one of the plurality of security domains of the organization formed under the plurality of governmental rules from a set of initializing inputs. The apparatus further includes a information risk assessment plan formed from the request for the information risk assessment, a set of information assessment templates and test cases formed from the information risk assessment plan, a set of information risk assessment tests conducted on the IT system using the assessment templates and test cases, a set of test results generated by the risk assessment tests, one or more security control gaps identified by the assessment responses and one or more gap remediation plans formed from the identified security gaps.

### FIELD OF THE INVENTION

The field of the invention relates to businesses and more particularly to governmental control of businesses.

### BACKGROUND OF THE INVENTION

Businesses operate in an environment of increasing complexity. At least some of the complexity is imposed by any of a number of different legally enforced regulations (e.g., the Sarbanes Oxley Act, Health Insurance Portability and Accountability Act, Gramm-Leach, Bliley Act). Other requirements are found within a number of other standards (e.g., the National Institute of Standards and Technology (NIST), the Federal Information System Controls Audit Manual (FISCAM), Control Objectives for Information and related Technology (COBIT), International Standards Organization (ISO), etc.).

Regulations are mandated to bring companies into alignment with accepted norms while standards are developed to assist companies in understanding what is involved in meeting regulatory requirements. Standards often are more specific in addressing the vagueness of the various regulations. Each of the standards addresses different facets of a business with at least some overlap. Some of the standards address corporate accounting, while other standards address security and how well the assets of a corporation are protected from theft or misuse.

Moreover, each of the standards may define a number of rules that have very specific requirements. Because of the number of rules, very few businesses have the technical talent to be familiar with (much less ensure compliance with) every rule.

In addition, the standards may be used for any of a number of different purposes. For example, publicly traded companies often require auditing of their business by independent third-party auditors to comply with the legal requirements of the Securities Exchange Commission. Often an auditor will be required to ask specific questions with regard to one or more rules. Even if the company is in full compliance with a rule, there may be no way to ensure compliance or even to identify the individual who is responsible for compliance with the rule or even if the risk has been assessed.

Similarly, companies offering business insurance may have certain minimum requirements with regard to corporate security that are addressed by certain of the standards. In order to address the insurance company's questions, an individual within the corporation must first understand the rules to understand the questions before he/she even begins the task of determining whether the corporation is in compliance with the rule. Because of the complexity of the business environment, a need exists for a better method of tracking business rules and regulations.

### SUMMARY

An apparatus is provided for evaluating risk to an organization. The apparatus includes a plurality of governmental rules directed to protecting shareholders, a plurality of security domains of the organization wherein each security domain is associated with a different asset of the organization and a request for an information risk assessment within at least one of the plurality of security domains of the organization formed under the plurality of governmental rules from a set of initializing inputs. The apparatus further includes a information risk assessment plan formed from the request for the information risk assessment, a set of information assessment templates and test cases formed from the information risk assessment plan, a set of information risk assessment tests conducted on the IT system using the assessment templates and test cases, a set of test results generated by the risk assessment tests, one or more security control gaps identified by the assessment responses and one or more gap remediation plans formed from the identified security gaps.

In another aspect, the apparatus for evaluating risk to a organizational includes a website that provides a questionnaire webpage for each respective security domain with questions directed to the asset of the security domain and where the questionnaire includes questions drawn from at least one of the governmental rules and an interactive window of the questionnaire webpage for entering answers to the questions.

### BRIEF DESCRIPTION OF THE DRAWINGS

FIG. 1 is a block diagram of an system for assessing risk in accordance with an illustrated embodiment of the invention;

FIG. 2 is a regulations webpage that may be provided by the system of FIG. 1;

FIG. 3 is a rules webpage related to one of the regulations shown in FIG. 2;

FIG. 4 is a questions webpage that relate to one of the rules shown in FIG. 3;

FIG. 5 is a flow chart that depicts the collection of risk assessment information accessible through the system of FIG. 1; and

FIG. 6 is a webpage associated with a particular security domain used by the system of FIG. 1.

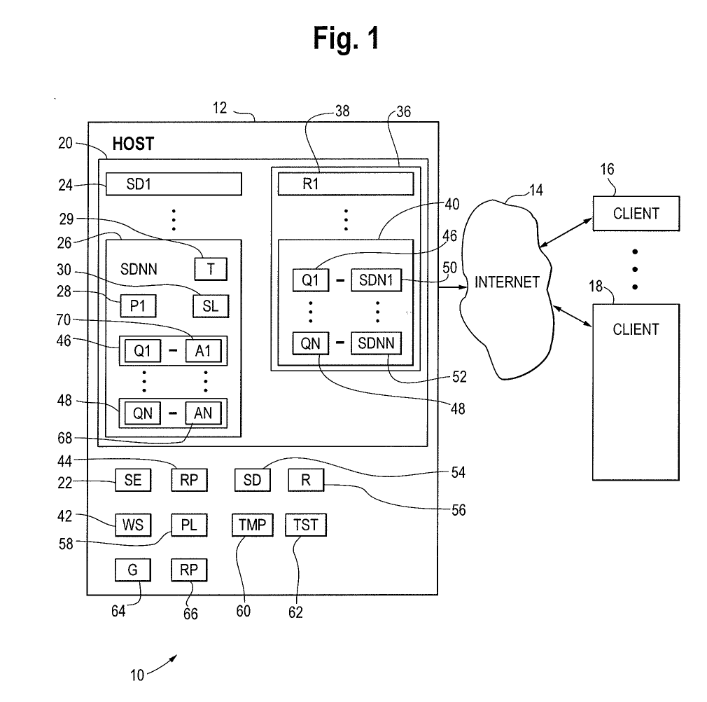

Appendix I contains exemplary questionnaires for at least some of the security domains of the system of FIG. 1.

### DETAILED DESCRIPTION OF AN ILLUSTRATED EMBODIMENT

FIG. 1 depicts a security compliance computer system 10 shown generally in accordance with an illustrated embodiment of the invention. The compliance system 10 can be used by any of a number of different types of organizations (e.g., corporations, partnerships, charities, etc.) to ensure compliance with appropriate external mandates.

Disclosed herein is a security compliance methodology and computer system 10 composed of a self-assessment process, program areas, and question sets for assessing and improving the effectiveness of security controls in accordance with specific regulations or standards. The process, composed of six phases, covers the steps of assessment initialization through gap analysis and validation to gap remediation. The tasks and specific deliverables associated with each phase guide the user through the process to arrive at a reasonable conclusion to address and prioritize compliance findings. The prioritization allows an organization (corporation) to easily identify which finding to remediate to comply with a regulation or standard.

The security compliance computer system 10 includes a host 12 with searchable database 20 that documents compliance with the applicable standards (e.g., Sarbanes Oxley, HIPAA, GLBA, NIST, FISCAM, COBIT, ISO, etc.). The database 20 is structured such that a user may ensure compliance with a rule by simply entering a standard and a rule identifier. In response, a search engine or processor 22 within the database 20 will identify the appropriate file 24, 26 that contains a status of compliance with the appropriate rule and, if necessary, any related rules. Since the database is indexed by the rule and rule number, it is accessible in a manner that is independent of any specific knowledge of a particular company or security system.

Included within any file 24, 26 identified by a rule search may be a list of internal corporate rules (policies) and procedures 28 for addressing the rule and, possibly, one or more site locations 30 where the rule is to be enforced. Also included within the file may be the title 29 of the person or group of persons responsible for enforcing the rule and for maintaining records that document the enforcement of the rule.

In addition, the file 24, 26 may contain information as to whether each respective policy and/or procedure has been implemented and whether they have been tested. The file may also contain information about whether the policy/procedure has been integrated with other policies/procedures of the organization and whether control of the policy/procedure is current and has been validated.

The database of question sets is based on security standards from NIST, COBIT, ISO, etc. and form the basis for the questionnaires. A number of questions 46, 48 are based on practical experience for performing security and compliance control assessments. The questionnaire is used to assess a specific program area, which is directly related to a regulation.

The database may contain one or more sets of questionnaires for evaluating risk management. Each of the questionnaires addresses a different facet of the rules. What differs between the series of program area questionnaires and the standards is that questions in the questionnaire may address more than one standard. As such, the answers 68, 70 to any particular questionnaire may be saved under any of a number of different corporate rules related to the standards.

The use of the questionnaires has a number of advantages. For example, a person does not have to understand the rules. He only has to understand the question. In addition, related rules from different standards may be consolidated into a single questionnaire or small number of questionnaires. This reduces the number of people who must be involved in answering the questions of each questionnaire since each questionnaire may now be directed to a particular portion of a corporate structure. This also streamlines the creation of corporate rules and procedures where such rules and procedures must be created to address a rule.

The program areas are based on a review and consolidation of both standards and regulations (e.g., Sarbanes Oxley, HIPAA, GLBA, NIST, FISCAM, COBIT, ISO, etc.). For example, the programs rules may be divided into 30 security domains, which include 1.) Risk Management; 2.) Information Security Policy; 3.) System Security Plan; 4.) Information Security Organization and Relationships; 5.) System Certification & Accreditation; 6.) Asset Classification; 7.) Review of System Security Controls; 8.) Security during the System Development Life Cycle; 9.) Security's Role in IT Technological Direction; 10.) Communicate Security's Direction; 11.) Assess Internal Controls; 12.) Personnel Security; 13.) Media Controls; 14.) IT Operational Controls; 15.) Disaster & Contingency Planning; 16.) Security During Hardware and System Implementation and Maintenance; 17.) Ensure System Security (Data Management); 18.) Physical and Environmental Protection; 19.) Documentation; 20.) Compliance; 21.) Security Awareness and Training; 22.) Incident Response Capability; 23.) Manage the Configuration; 24.) Manage Operations; 25.) Access Control; 26.) Audit Trails; 27.) Acquire and Maintain Application Software; 28.) Acquire and Maintain Technology Infrastructure; 29.) Manage Changes and; 30) Manage Third party Services (Managing Risk). A detailed discussion of the thirty different program areas and questions related to those areas follow below.

The security compliance computer system may be Internet or Intranet based. In either case, a web site 42 may be provided for access to the security compliance system 10. When the system 10 is Internet based, clients 16, 18 may access the website 42 through the Internet 14.

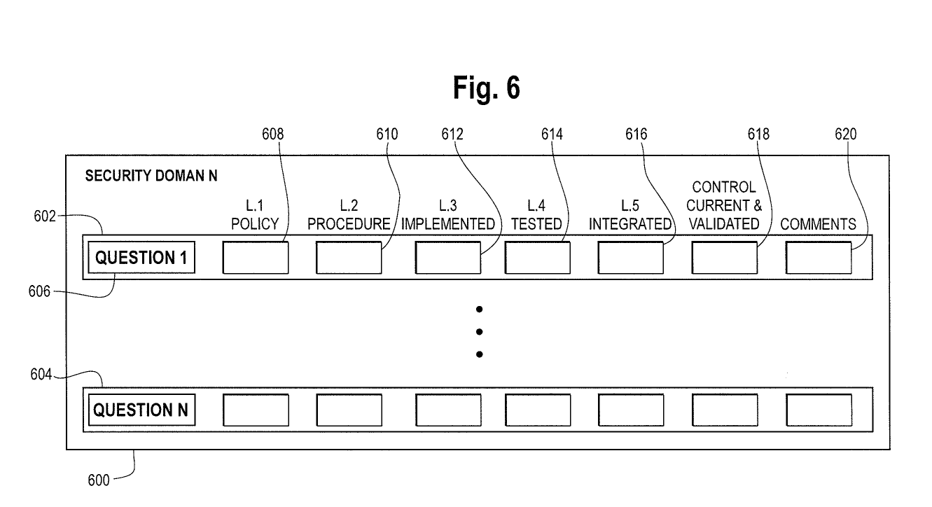

In order to evaluate risk, the questionnaires may be downloaded from the web site and completed on line. Appendix I depicts respective webpages of at least some of the 30 different security domains and the questions associated with the respective security domains. FIG. 6 is a webpage 600 that is representative of each of the webpages of the security domains that may be downloaded to a client 16, 18 through the website 42.

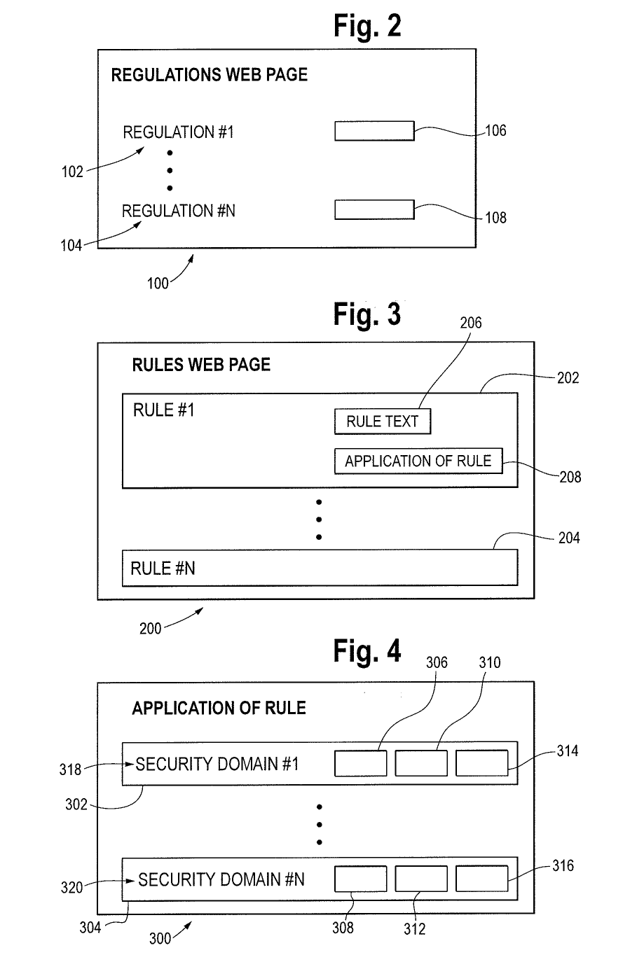

Alternatively, a user may access a rules web page 100 (FIG. 2) to audit specific rules one-at-a-time. When the user accesses a rules web page 100, the user may be presented with a first page providing a list of applicable regulations (e.g., Sarbanes Oxley, HIPAA, GLBA, NIST, FISCAM, COBIT, ISO, etc.) 102, 104. Located alongside each applicable rule may be a softkey 106, 108 for selection of a rule. The user may select a particular rule on the list (e.g., NIST) by activation of a particular softkey 106, 108 and be presented with a rules web page 200 including a list of NIST rules 202, 204. The NIST rules may each include text of the rules 206 and also another softkey 208 that allows a user to access a set of questions that are inclusive of a subject matter regarding compliance with the NIST rule.

For example, the user may select a softkey 208 associated with NIST SP 800-18. In response, a rules processor 44 may retrieve any questions 46, 48 associated with the rule 38, 40 and a associated security domain identifier 50, 52. The rules processor 46, 46 may then present the information on a questions webpage 300 (FIG. 4) with a reference list of questions 302, 304, each of which directly relate to NIST SP 800-18. Included within each text box 302, 304 may be an identifier of a security domain 318, 320 to which the question relates, the text of the question 308, 310 related to complying with the selected NIST rule and an answer 314, 316 previously provided to the question as discussed in more detail below.

Also included within the webpage 300 may be a softkey 306, 308 that provides access to the security domain questionnaires that have one or more questions that address NIST SP 800-18. For example, one of the headings will be labeled with the security domain heading “Risk Management” and another heading may be labeled “Security During the System Development Life Cycle” (See Appendix I).

If the user should select a softkey 306, 308 associated with Risk Management, then the user may be presented with a security domain webpage 600 that shows specific questions areas 602, 604 and a set of hyperlinks that provide answers to those questions. In the case of selection of NIST SP 800-18 and Risk Management, a first text box 602 may include the specific question of “Have the business critical systems been identified and documented in the IP Application Inventory.” Selection of this text box (hyperlink) 606 may present the user with a list of identified systems.

Associated with each question may be additional softkeys (hyperlinks) 608, 610, 612, 614, 616, 618, 620 that provide information about how risk is managed within the particular security domain. A first softkey 608 adjacent the question may be labeled “Policy.” Activation of this softkey may provide the user with a text window that shows company policy describing how business critical systems are identified. Another softkey 610 may provide the user with a text window showing information regard procedures for identifying business critical systems. Another softkey 612 may provide the user with information about how the identification procedure is implemented. Still another softkey 614 may describe how the procedures are tested. Still another softkey 616 may describe how the procedure is integrated with other procedures. Finally another softkey 618 may provide information about control procedures and who is assigned to control the procedure and whether the control has been validated. Each of the text windows 606, 608, 610, 612, 614, 616, 618, 620 may contain (or be amended to contain) hyperlinks to other information as discussed below.

Selection of other standards and rules shown in FIG. 4 result in the recovery of information related to other facets of the business organization and how its assets are managed. In each case, a specific policy, procedure, method of implementation, test method, integration arrangement and control schema is identified to allow access to supporting information.

In order to support of the use of the information retrieval system, one or more questionnaires may be downloaded from the web site 42 and information may be entered whenever appropriate. For example, each time a new business critical system is identified under NIST SP 800-18, the system generates a new thread that requires the input of information regarding a new policy, procedure, implementation, test, integration and control schema.

For example, if a user (client) 16, 18 should select NIST SP 800-18 on webpage 200, select Risk Management as the security domain on webpage 300 and add another site through the softkey associated with question 1.1, then the identification of another site spawns an additional processing thread(s) through the Risk Management security domain and through the “Security During the System Development Life Cycle” security domain (Appendix I). The additional thread may be generated by the rules processor 44. The rules processor 44 detects the entry of the new site and compares the entered information with a requirements list associated with each rule. If the rules processor 44 detects a discrepancy between the entered information and requirements list, then the rules processor 44 may generate a notification that more information is needed. In this case, the rules processor 44 may cause the softkeys 106, 108 associated with a particular rule (e.g., NIST SP 800-18) and respective security domains to begin alerting (e.g., flashing) to notify the client 16, 18 of the need to enter additional information.

In this example, the threads spawned by the entry of an identifier of a new site would also require that the new site be documented in the IT Application Inventory with linkages to other systems or third party services under question 1.1.1 of the Risk Management security domain (Appendix I, page 1-1). Entry of an identifier of a new site would also require the entry of information under questions 8.1.10 and 8.1.11 of the Security During the System Development Life Cycle security domain (Appendix I, page 8-2).

In general, each new business critical system requires completion of the questionnaire similar to that of Page 1-1 of Appendix I. However, completion of Page 1-1 causes information to be provided by the rule processor 44 to other related standards (e.g., FISCAM SP-1, COBIT Section P09, etc.). The provision of information to any of the other standards causes the system to generate other threads that requires the completion of (i.e., providing answers to questions within) other applicable questionnaires.

Each of the new threads may be routed as an “action needed” prompt to a particular person 29 responsible for providing the information associated with the questionnaire. As each new questionnaire is completed, the system may generate other threads that ensure a full complement of information related to each of the standards.

In addition to providing “action needed” prompts, the system may also alert the appropriate person/committee to outdated information or the need to update information. In this way, the system maintains an accurate updated database of business information.

Turning now to the system 10, an explanation will be provided of how the system is used. In general, a company's information assets are dispersed and as such are susceptible to a great deal of vulnerability and potential risk. A holistic view of information security must be adapted to effectively manage risk. The first step in risk management is to do a comprehensive risk assessment. A risk assessment identifies areas where security is exceptional and exposes the gaps which need to be remediated.

An information risk assessment (IRA) methodology is used to determine the security readiness of an entire organization from the business requirements to the technical solutions. IRA is based upon the use of the thirty security domain modules of Appendix I, which determine the readiness of the organization and provides a comprehensive list of potential security risks. The security assessment system 10 is based upon the use of control questions from three of the major security standards, NIST, ISO 17799, and COBIT. The combination of these standards provides a more comprehensive assessment tool than any other stand alone security standard. Assessments can be based upon one security domain at a time or any combination of security domains.

Once an assessment is completed, the organization's identified risks can then be analyzed and a series of mitigation tasks can be planned and executed to reduce the overall security vulnerabilities. A security baseline is established with the initially completed one or more questionnaires and which provides a reference point for future assessments. The assessment can be appended within the comments section 620 to any of the security modules and an audit trail created as problems are resolved and new security measures are implemented. The overall security of an organization can constantly be improved and documented. The repeatable use of the security/compliance system 10 reduces the cost of performing assessments and audits and provide more consistent results.

The system 10 may provide an integrated repository for storing the results of the IRA engagements, as well as other security and compliance assessments, outside audit findings, internal audit findings and other reported security gaps. This comprehensive set of security findings can used to produce a number of reports, which can assist teams conducting security/compliance audits and assessments. These reports can show the overall enterprise state of the organization's security or it can be tailored to specific types of findings such as Sarbanes-Oxley.

Having the organization's security and compliance findings in one database increases the overall enforcement of security and compliance policies. At the same time it will help to reduce the amount of time and cost to conduct security and compliance assessments and audits. If there is a current finding recorded in the database, then that would reduce the amount of time spent on subsequent reviews that in the past would have duplicated the same work.

The security of an organization must be viewed as a comprehensive enterprise-wide framework to be most effective. If security is implemented on a set of very narrow vertical (silo) solutions, rather than a comprehensive framework, there will most likely be gaps in the organization's protection. These gaps can present an opening into the organization's sensitive and confidential information assets.

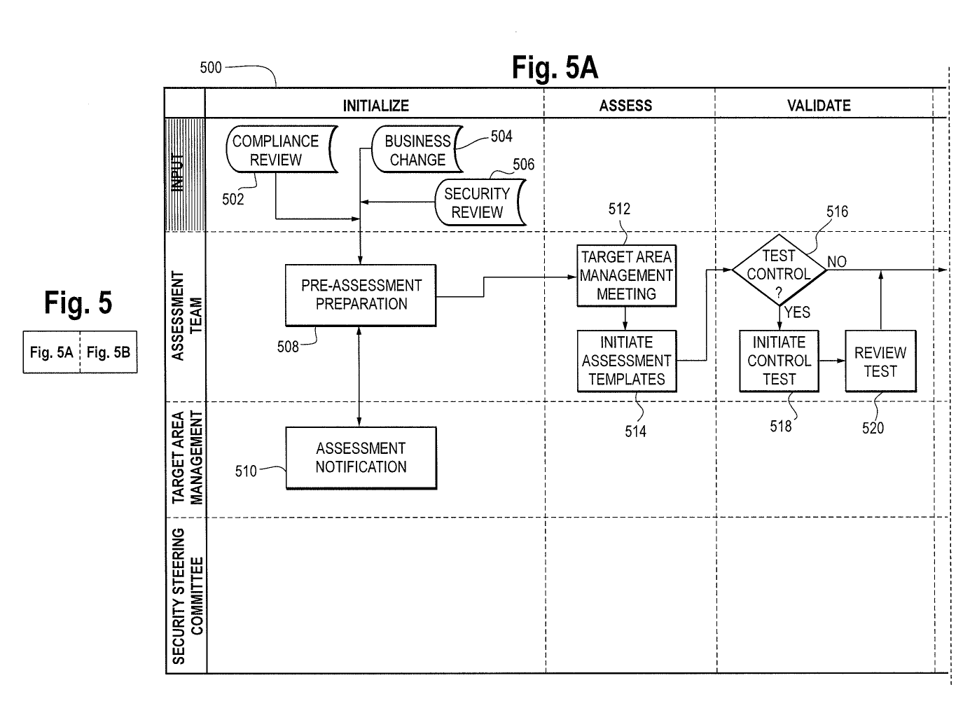

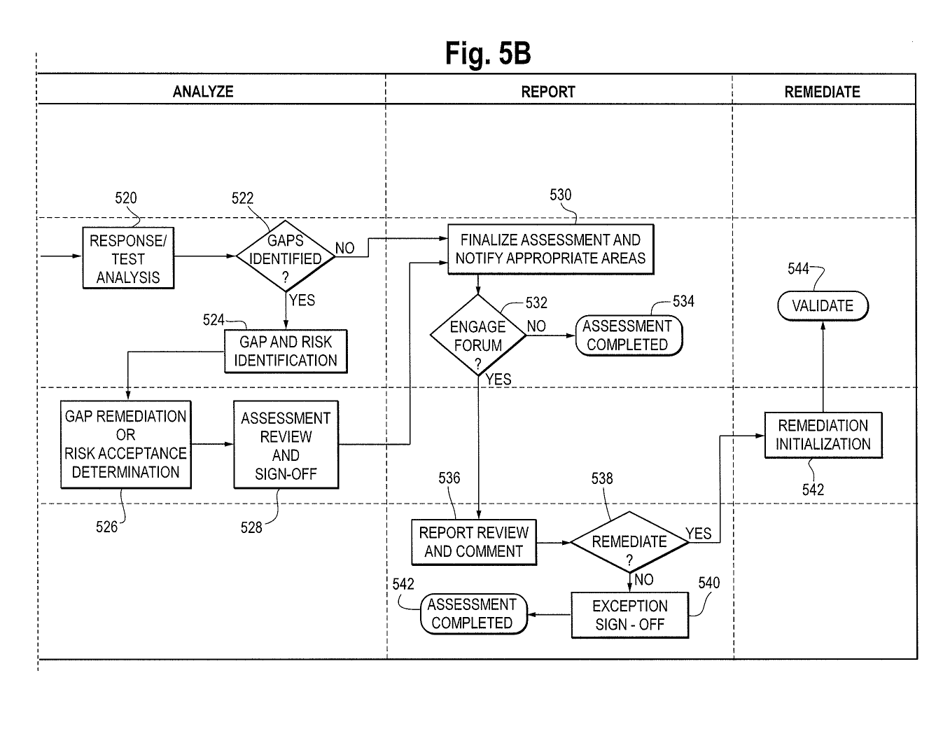

FIG. 5 is a flow chart of a process 500 that may be used in conjunction with the system 10 to audit compliance with the applicable regulations. As may be noted, the flow chart of FIG. 5 includes the steps of initialize, assess, validate, analyze, report and remediate. Some or all of these process steps may be omitted depending upon the circumstances.

An Information Risk Assessment (IRA) can be requested or initiated by any of a number of different departments within the organization. The need for an IRA can be triggered by any of a number of different factors, including a new or changed compliance regulation or a scheduled audit. In each case, the IRA team reviews the request 56 for completeness and clarity and then identifies the Security Controls to be used during the IRA. The IRA Plans may be reviewed with the management of the area targeted by the assessment.

The first step to initialize the process is to provide input to an information risk assessment request. An aspect of this process is to document the need (or driver) that triggers the information risk assessment. The driver or initiating factor may be a regulatory compliance law change 502, a new line of business or significant change in business 504, a notification of a regulatory audit, an internal audit or notification of an outside audit 506.

Another aspect of the initialization process may be to complete a set of information risk assessment request documents. In this regard, the role of the IRA requestor may documented as a compliance officer responsible for compliance review, a business manager responsible for changes in the business model or an auditor responsible for auditing functions. The departments involved may be a compliance related department, internal audit department, and the target department. The deliverable of the first phase may be an information risk assessment request formed from a set of initializing inputs.

Another aspect of the initiation process may be pre-assessment preparation 508 of an IRA proposal. In this regard a review of the information risk assessment request document may be required. For example, is the request complete? Are details provided to clearly identify a target assessment? Is form properly authorized?

Another aspect may be to identify summary group controls to be accessed, based on, such things as: 1) compliance regulation; 2) internal audit request and 3) external audit request. Summary group controls in this context refer to policy and regulations regarding access to the asset.

Another aspect is to review the information risk assessment request document. Is the form complete? Are details provided to clearly identify a security domain target for assessment? Is the form properly authorized?

Another aspect is to identify summary group controls to be accessed, based on: 1) compliance regulation; 2) internal audit request or 3) external audit request. In each case, policy and procedures would require different controls based upon execution of the assessment.

Another aspect is to identify the level of the Assessment to be conducted. The levels of assessment may be characterized as follows: 1) questionnaire responses—not verified; 2) questionnaire responses—with documentation of controls supplied to verify that controls are documented; 3) questionnaire responses—with documented controls analyzed to validate that identified controls are adequate and 4) questionnaire responses—with documented controls analyzed to validate that identified controls are adequate and test cases 62 executed to determine that the controls are effective.

Another aspect may be to complete the information risk assessment project initiation documentation as a proposal. Documentation may include: 1) the target area to be assessed; 2) the summary group controls selected; 3) the level of assessment to be conducted; 4) the expected IRA deliverables; 5) the identify of the number of IRA project resources required including IRA staff and target area staff and 6) the IRA project plan 58 with an estimated timeline.

With regard to the proposal, IRA management may assume the role of documenting this information. Information security may be the department involved and the deliverable may be an information risk assessment proposal.

Another aspect of the initialization process may be to gain approval of the planned information risk assessment. Approval may involve reviewing the information risk assessment initiation documentation with the target area management and IRA management.

Another aspect may be to validate the reason for the IRA. For example, is the target security domain consistent with the reason for the IRA. Consistency may be determined by accessing the questionnaire of the target security domain via the webpage 600. In this case, does the reason for the IRA require any additions of changes (or additions) to any the questions posed via the webpage 600.

Another aspect may be to determine the confidentiality of the IRA. For example, the IRA may be secret (i.e., the target Area is not informed). In this case, the assessment may involve penetration testing and the results may be privileged.

Alternatively, the penetration may be restricted (only target area personnel are informed or only high level personnel of the organization are informed). The penetration may also be unrestricted where information about the IRA is freely available to organizational personnel.

Another aspect may be to validate the level of IRA to be conducted. The level may be restricted to a high level in initial stages first following activation of the system 10 or to a more detailed analysis including one or multiple sites.

Another aspect may be notification of the assessment and approval of the expected deliverables 510. Expected deliverables may be validation of security controls for one or more systems or the identification of gaps 64 in security.

Another aspect may be to approve the IRA timeline and resource requirements. The timeline may be short term requiring only a few people or long term requiring multiple tests at numerous sites.

Another aspect may be to resolve any other target management and IRA management concerns. Concerns may be to interruptions in production or to disruptions caused by the testing.

Upon resolution of the approval phase, the target management may authorize the information risk assessment. In this regard, IRA and target management assume the role of providing approval of the planned information risk assessment. The information security and target area departments are the departments involved and the deliverable is the approved plan.

The target area management authorizes the assessment and commits required resources. The security controls are approved and distributed. Specific information is gathered, reviewed for completeness, and then documented in the integrated security repository. A hyperlink to the approved plan may be added to the comments box 620 of the target security domain.

Another aspect of this phase is to finalize the information risk assessment plan. In this regard, target area management authorizes and commits specific resources. An assessment Kickoff meeting is scheduled 512 including IRA team members, IRA management, target area management and target area team members. During the meeting, the IRA parameters are reviewed. Specific items reviewed include; the reasons for the IRA, the high level controls to be assessed, the confidentiality of the IRA and the level of the IRA. IRA management, target area management, IRA analysts and target area subject matter experts assume the role of finalizing the information risk assessment. The information security and target area departments are responsible for finalizing the plan and the deliverables are the kickoff meeting documentation.

Another aspect is to initiate and provide information risk assessment templates 60 and test cases 514. One step is to select the security controls by summary group and detailed security controls. Another step may be to review selected controls and to determine if controls can be assessed within the scope of the assessment based upon the time and resources allocated. If necessary, the number of controls to be assessed can be reduced, resources to the IRA Team can be added and/or the expected completion date of the assessment can be extended.

Another step may be to finalize and approve the selected controls. The detailed IRA timeline and resource plan may be developed. One or more information risk assessment templates may be developed or refined. One or more IRA control test cases as required may be identified. The templates may be involve known weaknesses in similar systems. The test cases may involve a set of steps to try to exploit the known weaknesses to overcome any firewalls or other access control structures.

IRA team members, target area team members serve in the role of identifying templates and test cases. The departments involved include information security and the target area department and the deliverables include one or more information risk assessment templates, IRA selected controls, an IRA final timeline, a resource plan, and IRA control test cases. A hyperlink to the deliverables may be added to the comments box 620 of the target security domain.

Another aspect is to gather IRA documentation. In this regard the involved departments may contact resource personnel in the target Area to explain the IRA, arrange schedules for interviews and questionnaires, conduct IRA control fact gathering interviews and distribute IRA control fact gathering survey forms.

The involved personnel may also manage the data collection in accordance with interview and questionnaire schedules. The process may involve rescheduling missed interviews, sending reminders for questionnaire responses that are overdue and contacting Target Area Management as needed to obtain cooperation and report any delays to IRA management. Data may be added to the security domain involved via the webpage 600.

The involved personnel may also determine an IRA documentation access level. The determined documentation access control level may be based upon a confidentiality level of the IRA.

The involved personnel may also function to confirm that responses are adequate. If the detail is not adequate, more detail may be requested and/or the number of people questioned may be increased.

Another aspect is to verify document responses. Verification may involve confirming or adding documents to the IRA Repository. Document links may also be added to policies, procedures, and other documentation to verify and validate the IRA controls via the webpage 600.

IRA team members, target area team members and target area resources may assume the role of gathering IRA documentation. Information security and target area departments are responsible for the gathering of the documentation and the deliverable is a documented IRA repository of information.

The validation process may be considered next. Depending upon the type of information risk assessment, there may be testing of a number of sample cases for certain security controls. The test cases and controls are analyzed to determine that they are adequate 516. The test cases are executed 518 to determine the effectiveness of the controls. The findings are documented in the integrated repository. One or more hyperlinks may be added to the appropriate interactive window 614 of the system 10.

Another aspect is to conduct information risk assessment testing. In this regard, personnel may further develop test cases to be used to determine the effectiveness of controls and further analyze proposed test cases to validate the viability of the controls. Personnel may also confirm that the IRA control is adequate. If the controls are not adequate, then the personnel may modify the control or select other controls.

Personnel may document the adequacy of the controls and select the appropriate number of test cases for each control. Personnel may also review the regulations and auditing standards to determine an appropriate number of cases. Personnel may also confer with internal audit to determine an appropriate number of cases. Personnel may also execute the IRA Test Cases to determine the effectiveness of the controls and document the findings.

In this case, IRA team members and target area team members may serve the role of conducting the IRA testing to collect a set of IRA responses. The departments involved are the information security and target area departments and the deliverable is test case documentation. As above, a hyperlink to the test case documentation may be added to the interactive window 614.

The review of test results 520 may be considered next. In this case, personnel may review the IRA test cases results with the target team management and responds to test case results in writing. The target team management may agree with results or disagree with results. Target team management may also agree (with reservations) or sign off on the findings.

In this case IRA management, target area management, IRA analysts and target area subject matter experts and internal auditor(s) may serve the function of reviewing test results. The departments involved may include the information security and target area departments and the deliverables may include an approved test case findings document.

The analysis of test results may occur next. The responses to the IRA, including any test results, will be analyzed by the IRA team to identify any gaps or non-compliance with the security controls being assessed. The target area team will develop remediation plans 66 for the identified gaps, which may be approved by the IRA team and the target area management. The target area management may also request a security exception indicating that the business area is accepting the potential risk.

An aspect of the analysis may include reviewing the IRA results and further documenting the results 520 via the system 10. In this case, a user may access a particular target security domain 302, 304 via selection of the appropriate softkey 306, 308. The user may be presented with a questionnaire and may enter information through the questionnaire on a number of different levels. On a first level, the user may enter information through the questionnaire in the case where the questions do not require any documentation or verification. In this case, the user may activate a softkey on the same row as the question in the L.4 column and enter information regarding the test including the date and test results. The user may also record answers to control questions (e.g., Question #1.2.2, Appendix I) in the same manner.

On another level, the user may analyze IRA responses and respond to questions where further documentation is required. The user may record answers to control questions and add hyperlink(s) to documentation. Alternatively, the user may record answers whether documentation is presented or not.

On another level, the questionnaires require documentation and verification of the strength of the controls. In this case, the user may record answers to control questions, record links to documentation and/or record if documentation is presented or not. The user may also determine if the control(s) are adequate or not and document either directly or via a hyperlink.

On another level, the user may analyze IRA responses and respond to questionnaires with test cases. In this situation, the user may record answers to control questions, enter links to documentation and/or record if documentation is presented or not. The user may also determine if the control is adequate or not and document and record results of test cases (either directly or via a hyperlink) to determine the effectiveness of the control.

IRA team members, target area team members assume the role of analyzing IRA responses. The information security and target area department may be responsible for the analysis.

In another aspect, the process may involve the identification of security control gaps 524. In this case, a user may document control gaps identified during the IRA. Control gaps documented through the appropriate window of Appendix I may be due to undocumented policies, procedures or standards. Alternatively, the documented control gaps may be due to inadequate or ineffective policies, procedures or standards.

The user may also generate IRA control templates documenting all gaps that were identified. The user may also obtain authorized signatures confirming the IRA control findings

In this case, the IRA team members and target area team members occupy the role of documenting control gaps. The information security and target area departments are responsible for documentation and the deliverables are a signed information risk assessment template.

In another aspect, the process may require a user to determine gap remediation 526. The target area personnel analyze identified gaps and the potential remediation efforts and estimate the potential remediation efforts in time and cost and the severity of the identified potential security risk. The target area will also determine if the gap can be remedied in a reasonable amount of time and at a cost that is commensurate with the potential security risk. If it is not reasonable because of the amount of time and money to fix the gap, a security exception may be documented and with an established process to be followed in dealing with the gap. If the likelihood of the potential risk is insignificant, a user may again document a security exception and follow that established process.

In general, the target area will provide a plan to fix the gap, if the identified gap can be remedied in a reasonable amount of time and money or the likelihood of the potential risk is significant. In addition, the target area will identify a high level solution to the gap and will review the solution with the IRA team. If the IRA team determines that the solution will resolve the security problem, they will then approve 528 the planned solution. If the IRA team determines that the solution will not resolve the security problem, then they will then disapprove and reject the planned solution. The target team will then identify another solution. The target area will then develop a remediation plan with cost estimates and present the plan to target team management for approval. Target team management will review the remediation plan and proceed along one of a number of paths as follows: 1) approve plan and initiate the established BNR process; 2) disapprove plan; 3) recommend modifications to remediation plan, which must then be approved by the IRA team or 4) seek a security exception and follow that established process.

The target area management, IRA analysts and target area subject matter experts serve the role of determining a gap remediation. The information security and target area department are the departments responsible and the deliverables is a security exception form and/or BNR Form.

In another aspect, the process may involve finalizing and reporting 530 on the results of the IRA. In this regard, the IRA team will review the completed IRA documentation and resolve any issues with the target area management. If necessary, the security steering committee will resolve any issues between the IRA team and the target area. The IRA team will document all of the findings in the repository through the webpage 600 and issue reports to the appropriate people on a need to know basis.

The finalize assessment may include a review information risk assessment template. This may involve obtaining authorized approval signatures once the IRA template is completed.

Finalization may also include the review of security exception forms. If the security exception form is complete, the authorized approval signatures may be obtained.

A requirement for signatures may be the additional step of determining if the requested security exception is reasonable. If risk level is not reasonable, then a user may contact the target area management to explain concerns. This may result in the resolution of the issue or the engagement of the information security steering committee to resolve the disputed security exception request. In this case, if the risk level is reasonable, then the committee may approve the assessment and the IRA is complete.

Alternatively, the committee may review the recommended actions to remedy any identified gaps and determine if the planned remediation action is reasonable. If the risk level is not reasonably reduced by the remedy, then the committee may contact the target area management to explain concerns. The discussion may resolve the issue or the user may then proceed to develop a report in order for the security steering committee to provide a clear unbiased view of the disputed plan. This may involve engaging the information security steering committee to resolve the disputed plan.

If the risk level is reasonable, then the steering committee may approve the remedy. Once approved, the steering committed may notify target management. The IRA team must be part of the remediation project progress reporting approval process. The steering committee will document all findings and approve the IRA template 534.

In this case, the target area management, IRA analysts and target area subject matter experts serve the role of approving the remedy. The information security and target area department are the departments responsible and the deliverables are security exception form and/or information risk assessment template.

Alternatively, the decision may be presented to a forum 532. In this case, the forum may include review 536 by a security steering committee. The steering committee may review the information risk assessment documentation, the information risk assessment template, the security exception form and the IRA report explaining the disputed plan to remediate or accept the identified risk. The steering committee may analyze the findings and decide whether remediation 538 is necessary.

The steering committee may grant the security exception. If the steering committee grants the security exception, the target area management is notified that they must accept the potential risk 540 and not pass the responsibility on to information technology and must notify the IT security team of the decision.

Alternatively, the steering committee may deny the security exception and notify the target area management of the reasons for denying the security exception. The steering committee may then notify the target area management that a plan acceptable to Information Security must be developed and implemented to remediate the risk and may notify information security 542.

The target area management, IRA analysts and security steering committee members assume the role of reviewing the report. The information security, target area department are responsible for committee review.

The information risk assessment may be completed as follows. A final information risk assessment report may be developed including the information risk assessment template, the security exception form and gap remediation plans. A review may be conducted with the compliance department. The review may identify any regulatory compliance issues and determine the roles and level of access to the IRA documents.

The IRA documentation may be completed. Once completed, links to the IRA documentation may be distributed to the appropriate people.

The Remediation Project Manager may be notified that checkpoints in the SDLC process will require information security review and signoff at predetermined points in the development process. At the completion of the remediation project, an information risk assessment of the final deliverable will need to be performed to determine if the gaps have been successfully resolved. The target area management, IRA analysts, compliance department, remediation project manager(s) assume the role of completing the information risk assessment.

A specific embodiment of method and apparatus for conducting risk assessments have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. An apparatus for evaluating risk to an organization comprising:
a plurality of governmental rules directed to protecting shareholders;
a plurality of security domains of the organization wherein each security domain is associated with a different asset of the organization;
a request for an information risk assessment within at least one of the plurality of security domains of the organization formed under the plurality of governmental rules from a set of initializing inputs;
a information risk assessment plan formed from the request for the information risk assessment;
a set of information assessment templates and test cases formed from the information risk assessment plan;
a set of information risk assessment tests conducted on the IT system using the assessment templates and test cases;
a set of test results generated by the risk assessment tests;
one or more security control gaps identified by the assessment responses; and
one or more gap remediation plans formed from the identified security gaps.

2. The method of evaluating organizational risk as in claim 1 wherein the plurality of security domains further comprises a security domain target for the risk assessment test selected from the group consisting of 1) risk management, 2) information security policy, 3) system security plan, 4) information security organization and relationships, 5) system certification and accreditation, 6) asset classification, 7) review of system security controls, 8) security during a system development life cycle, 9) security's role in IT technological direction, 10) communicate security's direction, 11) assess internal controls, 12) personnel security, 13) media controls, 14) IT operational controls, 15) disaster and contingency planning, 16) security during hardware and system implementation and maintenance, 17) ensure system security (data management), 18) physical and environmental protection, 19) documentation, 20) compliance, 21) security awareness and training, 22) incident response capability, 23) manage a system configuration, 24) access control, 25) audit trails, 26) acquire and maintain application software, 27) acquire and maintain technology infrastructure, 28) manage changes and 29) manage third-party services (managing risk).

3. The method of evaluating organizational risk as in claim 2 further comprising a standards webpage with an interactive standards window for entry of an identifier of a regulation or standard.

4. The method of evaluating organizational risk as in claim 3 further comprising a standards processor that identifies to a user a target security domain and any control objectives and techniques related to the identified standard or regulation.

5. The method of evaluating organizational risk as in claim 4 further comprising a target domain file that contains security information regarding the identified target security domain and any control objectives or techniques related to the standard or regulation.

6. The method of evaluating organizational risk as in claim 5 wherein the security information further comprises information selected from the group consisting of policy, procedures, implemented policies and/or procedures, tested policies and/or, integrated policies and/or procedures and whether control by the policy and/or procedures is current and validated.

7. The method of evaluating organizational risk as in claim 6 further comprising a compliance webpage that displays an icon for each of the target security domains and objectives and techniques related to the entered identifier and wherein the standards processor displays to the user any policy, procedure, implemented, tested, integrated and control current and validated information upon selection of the respective icon.

8. The method of evaluating organizational risk as in claim 2 further comprising a security domain webpage for the security domain target having a plurality of interactive windows with at least some of the plurality of interactive windows reserved for each of a plurality of control objectives and techniques.

9. The method of evaluating organizational risk as in claim 8 wherein the at least some interactive windows of each of the control objectives and techniques further comprises entry/retrieval windows for security domain information selected from the group consisting of policy, procedures, implemented policies and/or procedures, tested policies and/or procedures, integrated policies and/or procedures and whether control is current and validated.

10. The method of evaluating organizational risk as in claim 9 further comprising a objectives and techniques processor that accepts/provides security domain information through the at least some interactive windows.

11. The method of evaluating organizational risk as in claim 1 wherein the initializing inputs further comprises regulatory compliance law changes.

12. The method of evaluating organizational risk as in claim 1 wherein the initializing inputs further comprises a new line of business for the corporation.

13. The method of evaluating organizational risk as in claim 1 wherein the initializing inputs further comprises one of the group consisting of a regulatory audit, an internal audit and an outside audit.

14. The method of evaluating organizational risk as in claim 13 further comprising a set of summary group controls to be accessed within the security domain target based upon one of compliance regulation and internal audit request.

15. The method of evaluating organizational risk as in claim 1 further comprising a plurality of questions directed to each of the governmental rules where the questions are inclusive of a subject matter of the governmental rule and where at least some of the questions of the governmental rule are associated with different security domains of the plurality of security domains.

16. The method of evaluating organizational risk as in claim 15 further comprising a website that provides a questionnaire webpage for each respective security domain with questions directed to the asset of the security domain and where the questionnaire includes questions drawn from at least one of the governmental rules.

17. The method of evaluating organizational risk as in claim 16 further comprising an interactive window of the questionnaire webpage for entering answers to the questions.

18. An apparatus for evaluating risk to a organizational comprising:
a plurality of governmental rules directed to protecting shareholders;
a plurality of security domains within the corporation wherein each security domain is associated with a different asset of the corporation;
a plurality of questions directed to each of the governmental rules where the questions are inclusive of a subject matter of the governmental rule and where at least some of the questions of the governmental rule are associated with different security domains of the plurality of security domains;
a website that provides a questionnaire webpage for each respective security domain with questions directed to the asset of the security domain and where the questionnaire includes questions drawn from at least one of the governmental rules;
an interactive window of the questionnaire webpage for entering answers to the questions.

19. The apparatus for evaluating risk as in claim 15 further comprising the website providing a governmental rules webpage with a hyperlink to at least some of the governmental rules of the plurality of governmental rules and each of the at least some governmental rules has a hyperlink to the plurality of questions and respective answers for each of the questions of the governmental rule.

20. The apparatus for evaluating risk as in claim 19 further comprising a request for an information risk assessment within at least one of the plurality of security domains of the organization formed under the plurality of governmental rules from a set of initializing inputs.

21. The apparatus for evaluating risk as in claim 15 further comprising a information risk assessment plan formed from the request for the information risk assessment.

22. The apparatus for evaluating risk as in claim 15 further comprising a set of information assessment templates and test cases formed from the information risk assessment plan.

23. The apparatus for evaluating risk as in claim 15 further comprising a set of information risk assessment tests conducted on the IT system using the assessment templates and test cases.

24. The apparatus for evaluating risk as in claim 15 further comprising a set of test results generated by the risk assessment tests.

25. The apparatus for evaluating risk as in claim 15 further comprising one or more security control gaps identified by the assessment responses and one or more gap remediation plans formed from the identified security gaps.

26. An apparatus for evaluating risk to an organization comprising:
an information risk assessment request of an IT system formed from a set of initializing inputs;
an information risk assessment proposal prepared from the information risk assessment request;
a information risk assessment plan approved from the information risk assessment proposal;
a information risk assessment plan finalized from the approved planned information risk assessment;
a set of information assessment templates and test cases formed from the finalized information risk assessment plan;
information risk assessment documentation gathered from the corporation based upon the assessment templates and test cases;
a set of information risk assessment tests conducted on the IT system using the assessment templates and test cases;
a set of test results generated by the risk assessment tests;
a set of information risk assessment responses that are generated from the test results;
one or more security control gaps identified by the assessment responses;
one or more gap remediation plans formed from the identified security gaps; and
a finalizing assessment formed from the gap remediation plans.
